(19) United States
(12) Patent Application Publication
(10) Pub. No.: US 2008/0277424 A1
(43) Pub. Date: Nov. 13, 2008

(54) Flip-top shaker

(76) Inventors: Robert Larimer, New York, NY (US); Edward Kilduff, New York, NY (US); William Kang, New York, NY (US); Chun Ming Cheung, Hong Kong (HK)

Correspondence Address: Pearl Cohen Zedek Latzer, LLP, 1500 Broadway, 12th Floor, New York, NY, 10036, US

(21) Appl. No.: 11/798,185

(22) Filed: May 10, 2007

(51) Int. Cl. B67D 5/58; B67D 5/06

(52) U.S. Cl. 222/189.07; 222/536

(57) ABSTRACT

A flip-top shaker for mixing and pouring is presented. The flip-top shaker may include a container sealed with a collar which may be integrated with a strainer assemblage. The strainer assemblage may be pivoted to a first position in which the flip-top shaker may be completely sealed. In this position the shaker may be shaken with one hand for mixing the contents of the container without holding any of the components together to maintain the seal. The strainer assemblage may be pivoted to a second position in which a passageway is opened allowing communication between the container and the outside. In this position the shaker may be tilted for pouring the contents of the container.

### BACKGROUND OF THE INVENTION

1. Field of the Invention

The present invention relates to a device for mixing and pouring liquids. In particular, the present invention relates to a device that may alternately pivot between two positions. In the first position a liquid-tight seal is provided and the device may be suitable for mixing liquids while in the second position a passageway is provided and the device may be suitable for pouring liquids.

2. Description of the Related Art

In the preparation of various beverages, it may be necessary to mix and combine various liquid ingredients such as fruit juice, water, liquor, and the like. These beverages may also be mixed with various solid ingredients, such as ice or fruit, after which it may be necessary to remove the solid ingredients. A cocktail shaker is a well-known device used for the mixing and pouring of such beverages. However, the composition and operation of existing cocktail shakers have several shortcomings. Cocktail shakers typically include a container for holding the various liquid and solid ingredients of the beverage. The container is often covered with a lid having a built-in strainer. The strainer is typically sealed with a cap. Once sealed, the container is shaken to thoroughly mix the ingredients. The cap is then removed and the beverage is poured through the strainer such that only the liquid ingredients flow from the container while the solid ingredients remain therein A shortcoming of this type of cocktail shaker is that three components are necessary to mix, pour, and strain the beverage. Another shortcoming is that both hands are needed to mix the beverage

### SUMMARY OF THE INVENTION

In an embodiment of the invention a lid adapted for fitting on a container may include a collar having a first orifice, wherein the collar is adapted to detachably seal with the container. The lid may further include a strainer assemblage having a second orifice and a third orifice, wherein the strainer assemblage is adapted to move between a first position and a second position within the collar, and wherein the first position provides a liquid-tight seal between the strainer assemblage and the collar and the second position provides a passage through the first, second, and third orifices.

In another embodiment of the invention a sealable vessel may include a container adapted for holding solid and liquid ingredients. The vessel may further include a collar having a first orifice, wherein the collar is adapted to detachably seal with the container. The vessel may further include a strainer assemblage having a second orifice and a third orifice, wherein the strainer assemblage is adapted to move between a first position and a second position within the collar, and wherein the first position provides a liquid-tight seal between the strainer assemblage and the collar and the second position provides a passage through the first, second, and third orifices.

### DESCRIPTION OF THE DRAWINGS

Embodiments of the invention will be understood and appreciated more fully from the following detailed description taken in conjunction with the drawings in which like reference numerals indicate corresponding, analogous, or similar elements, and in which:

FIG. 1 shows an isometric view of an embodiment of a double-walled container;

FIG. 2 shows an isometric view of an embodiment of an outer wall of the double-walled container of FIG. 1;

FIG. 3 shows an isometric view of an embodiment of an inner wall of the double-walled container of FIG. 1;

FIG. 4 shows an isometric view of an embodiment of a collar;

FIG. 5 shows a cross-sectional isometric view through the center of the collar of FIG. 4;

FIG. 6 shows a side view of an embodiment of a strainer assemblage;

FIG. 7 shows a cross-sectional isometric view through the center of the strainer assemblage of FIG. 6;

FIG. 8 shows an isometric view of an embodiment of a bottom cabinet portion of the strainer assemblage of FIG. 6;

FIG. 9 shows an isometric view of an embodiment of a top cabinet portion of the strainer assemblage of FIG. 6;

FIG. 10 shows a side view of an embodiment of a fully assembled flip-top shaker; and

FIG. 11 shows a cross-sectional side view through the center of the fully assembled flip-top shaker of FIG. 10 with the strainer assemblage pivoted to a first position.

FIG. 12 shows a cross-sectional side view through the center of the fully assembled flip-top shaker of FIG. 10 with the strainer assemblage pivoted to a second position.

### DESCRIPTION OF THE PREFERRED EMBODIMENT

In the following description, various aspects of the present invention will be described. For purposes of explanation, specific configurations and details are set forth to provide a thorough understanding of the present invention. However, it will also be apparent to one skilled in the art that the present invention may be practiced without many specific details presented herein.

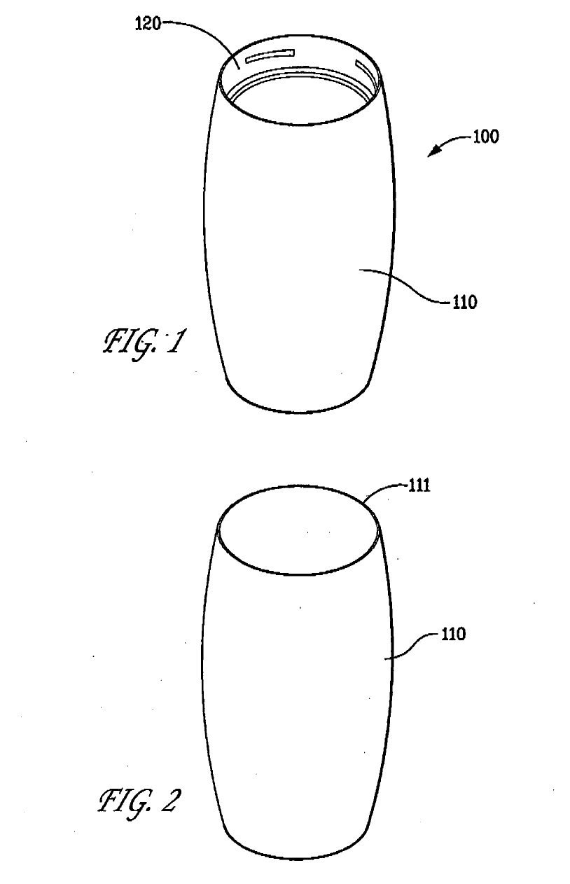

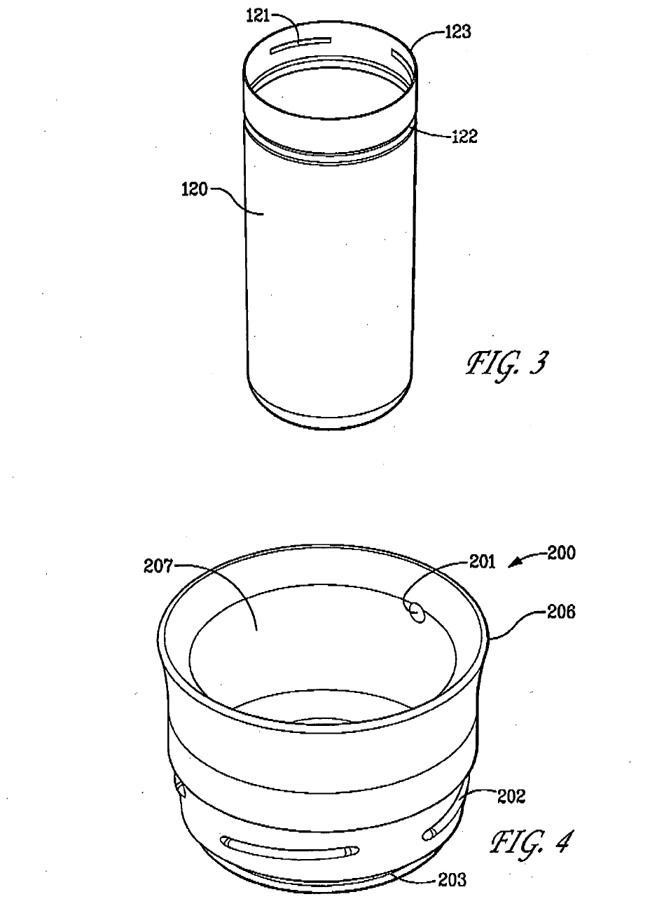

FIG. 1 shows an isometric view of an embodiment of a container 100. In an embodiment of the invention, the container 100 may be a double-walled container. In another embodiment of the invention, the container 100 may be a single-walled container. In embodiments of the invention in which the container 100 may be a double-walled container; the container 100 is generally constructed from an outer wall and an inner wall 120. An isometric view of an embodiment of the outer wall 110 is shown in FIG. 2. An isometric view of an embodiment of the inner wall 120 is shown in FIG. 3. The inner wall 120 and the outer wall 110 may be hollow and have a generally cylindrical shape. Alternately, the outer wall 110 may have a generally barrel shaped profile. The inner wall 120 and the outer wall 110 may be manufactured from a variety of materials such as plastic, stainless steel, and the like.

The inner wall may be adapted for fitting within the outer wall A circumferential lip 111 of the outer wall may be joined with a circumferential lip 123 of the inner wall for forming the integral double-walled container. The outer wall and the inner wall may be manufactured as distinct components which are fused at their circumferential lips 111 and 123. Alternately, the outer wall and the inner wall may be manufactured as a single unit such that the two are joined along their circumferential lips 111 and 123. The outer wall and the inner wall may be connected to each other at other points by various connecting structures such as struts as is well known in the art. However, it may be preferable that the outer wall and the inner wall only contact each other along their circumferential lips 111 and 123.

The inner wall may be adapted such that when it is joined with the outer wall a gap exists between the outside of the inner wall and the inside of the outer wall. This gap creates a thermally insulative barrier between the inside of the inner wall and the outside of the outer wall. This gap may be filled with a fluid such as air; other gases or a liquid. The gap may also be filled by a thermally insulative material such as fiberglass, ceramic, or the like. Alternately, the gap may contain a vacuum. This barrier serves to limit condensation on the outside of the outer wall from cold materials placed within the inner wall. The barrier also serves to lengthen the time during which materials placed within the inner wall may approach thermal equilibrium with the outer environment.

FIG. 4 shows an isometric view of an embodiment of a collar 200. FIG. 5 shows a cross-sectional isometric view taken through the center of the collar 200. The collar 200 may be hollow and have a generally cylindrical shape which is adapted for mating with the container. The collar 200 and the container may have a generally sinusoidal profile when mated. The collar 200 may be manufactured from a variety of materials such as plastic, stainless steel, and the like.

The inner wall may have an attachment means 121 which may be adapted for mating with a corresponding attachment means 202 of the collar The attachment means 121 of the inner wall and the corresponding attachment means 202 of the collar may be adapted for ensuring that liquid contained within the inner wall cannot leak from the seam between the double-walled container and the collar. In one embodiment, the attachment means 121 and the corresponding attachment means 202 may be corresponding screw threads. In another embodiment, the attachment means 121 and the corresponding attachment means 202 may be the slots and pins of a bayonet mounting system. In such an embodiment, a compression means (not shown) may provide a clamping force for keeping the double-walled container and the collar mated. In another embodiment, one of the attachment means 121 and the corresponding attachment means 202 may be substantially smooth while the other may be a press-fit mechanism or gasket adapted for sealing with a substantially smooth surface.

The inner wall may have an inner circumferential ridge 122 which is adapted for mating with a gasket 203 of the collar. The gasket 203 may be integral to or separable from the collar. When the collar is mated with the double-walled container, the gasket 203 may be compressed against the circumferential ridge 122 creating a liquid-tight seal. This seal further ensures that liquid contained within the inner wall cannot leak from the seam between the double-walled container and the collar. The circumferential ridge 122 may be located below the attachment means 121 such that the ridge 122 and the gasket 203 form a primary liquid-tight seal and the attachment means and the corresponding attachment means form a secondary liquid-tight seal. Alternately, the circumferential ridge 122 may be located above the attachment means such that the attachment means and the corresponding attachment means form a primary liquid-tight seal and the ridge 122 and the gasket 203 form a secondary liquid-tight seal. The gasket may be made of rubber, plastic, an elastomeric material or the like.

As shown in FIG. 5, the collar may have an orifice 204. The orifice 204 may be at least partially coveted by a straining mechanism. This straining mechanism may be integral to the orifice 204 or may detachably attach to the orifice 204. The straining mechanism may have small or large gradations for selectively allowing or filtering ingredients passing through the mechanism. When the collar is mated with the container; the orifice 204 may extend into the container and liquid may flow from the container through the orifice 204. The collar may have a circumferential lip 206 which is wider than and extends away from the body of collar to aid in pouting liquids. Circumferential lip 206 may also have a spout to further aid in pouring liquids.

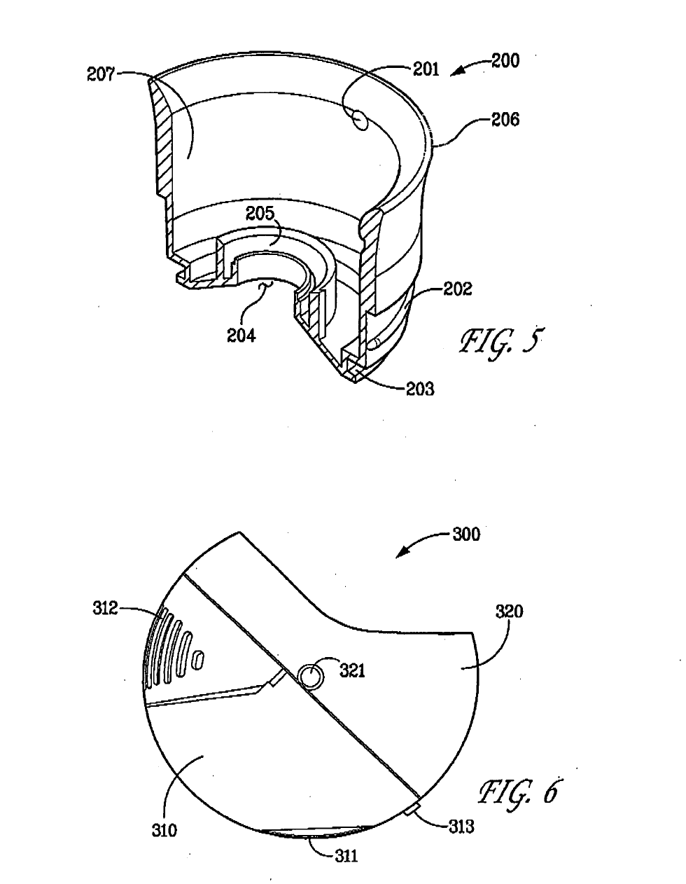

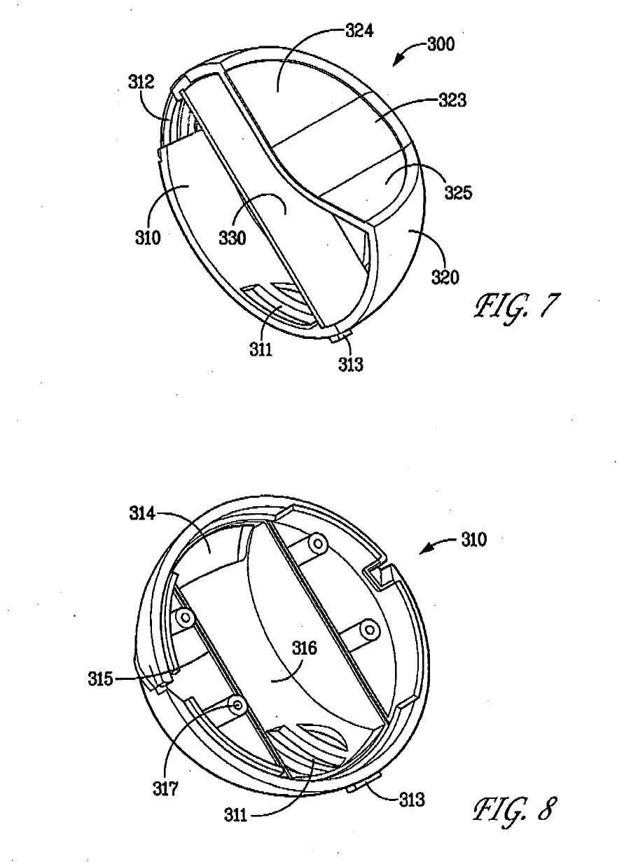

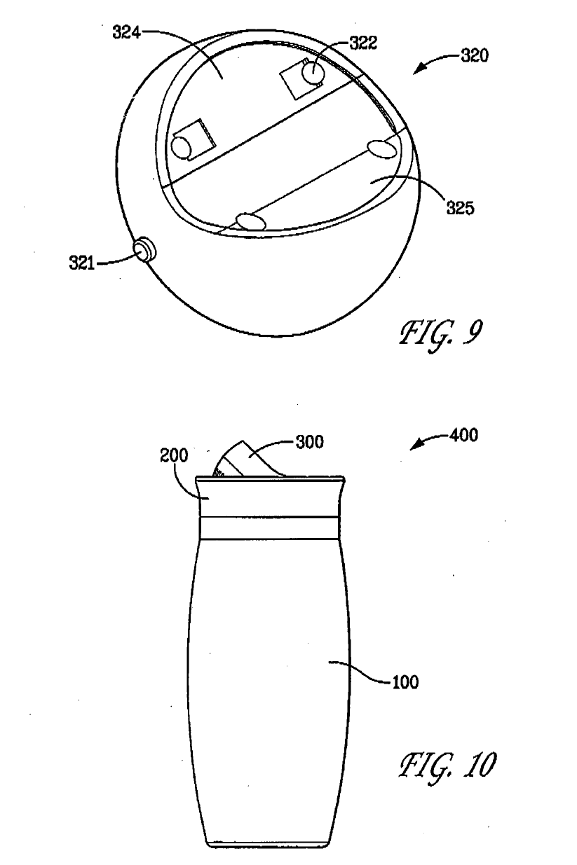

FIG. 6 shows a side view of an embodiment of a strainer assemblage 300. FIG. 7 shows a cross-sectional isometric view taken through the center of the strainer assemblage 300. The strainer assemblage 300 may be hollow and have a generally spherical shape. The strainer assemblage 300 may be constructed from a bottom cabinet portion 310 and a top cabinet portion 320. An isometric view of an embodiment of the bottom cabinet portion 310 is shown in FIG. 8. An isometric view of an embodiment of the top cabinet portion 320 is shown in FIG. 9. The strainer assemblage 300 may be manufactured from a variety of materials such as plastic, stainless steel, and the like.

As shown in FIG. 5, the collar may have a cavity 207 which may be adapted for fitting the strainer assemblage. The strainer assemblage may have pins 321 adapted for mating with holes 201 of the collar such that the strainer assemblage may operably pivot back and forth within the cavity 207 along an axis line centered through the pins 321. When the strainer assemblage and the collar are mated, the strainer assemblage may be irremovably fitted within the collar. Alternately, the strainer assemblage may be removably mated with the collar. The collar may also contain a gasket 205 around the orifice 204 for sealing with the strainer assemblage. The gasket 205 may be integral to or separable from the collar. When the strainer assemblage is mated with the collar, the gasket 205 may be compressed against the strainer assemblage creating a liquid-tight seal between the orifice 204 and the strainer assemblage. The gasket may be made of rubber, plastic, an elastomeric material, or the like.

As shown in FIGS. 8 and 9, the bottom cabinet portion may have mating posts 317 and the top cabinet portion may have corresponding mating posts 322 which may be used for joining the cabinet portions to each other for forming the strainer assemblage. The mating posts 317 and 322 may be formed such that when joined the two lock together. Alternately, an additional attachment means may be necessary such as a screw, an adhesive, or the like. Although joined together during operation, the cabinet portions may be designed for separating for cleaning or maintenance When the cabinet portions are joined, a liquid tight seal may be formed along the seam therebetween. The bottom cabinet portion may have mounting tails 315 which define a cavity 316 within the bottom cabinet portion.

The bottom cabinet portion may have an orifice 311 which provides an opening to the cavity 316. The orifice 311 may be at least partially covered by a straining mechanism. This straining mechanism may be integral to the orifice 311 or may detachably attach to the orifice 311. The straining mechanism may have small or large gradations for selectively allowing or filtering ingredients passing through the mechanism. The bottom cabinet portion may have a second orifice 314 which provides an opening to the cavity 316. The orifices 311 and 314 may be located at distal ends to the cavity 316. The orifice 314 may be at least partially covered by a straining mechanism 312. The straining mechanism 312 may be integral to the orifice or may detachably attach to the orifice. The straining mechanism 312 may have small or large gradations for selectively allowing or filtering ingredients passing through the mechanism.

The cavity may be covered by a ramp 330. The ramp 330 may seal the cavity with a liquid-tight seal thus sealing the cavity from the remainder of the strainer assemblage. When the cavity is sealed by the tamp 330, liquid may only enter or exit the cavity by means of the orifices 311 and 314.

The top cabinet portion may be shaped to assist a user in pivoting the strainer assemblage back and forth within the collar about the axis defined by the pins 321. For example, top the cabinet portion may have partially opposing faces 324 and 325 orthogonal to and distal from the axis line centered through the pins 321. The faces 324 and 325 provide a means for operatively pivoting the assemblage. By pushing the face 324, the strainer assemblage may pivot to a first position. By pushing the face 325, the strainer assemblage may pivot to a second position. The strainer assemblage and the collar may have a locking mechanism (not shown) for locking the strainer assemblage within the collar in the first or second pivoted position. The locking mechanism may also release the strainer assemblage from the locked position. The locking mechanism may be a detent or the like. The bottom cabinet portion may have a stop 313 for preventing the strainer assemblage from pivoting past a certain position. Alternately, the stop 313 may be on the top cabinet portion or on the collar. The top cabinet portion may also include a face plate 323 for covering the partially opposing faces and the mating posts 322. The face plate 323 may be made of stainless steel, plastic, or the like.

FIG. 10 shows a side view of an embodiment of a fully assembled flip-top shaker 400. As is shown in FIG. 10, the collar 200 may be mated with the strainer assemblage 300. The collar and strainer assemblage may be removed from container 100, and various liquid and solid ingredients may be placed within the container. The collar and the strainer assemblage may then be reattached to the container such that a liquid-tight seal may be created by the gasket 203 and the attachment means 121 and 202 along the seam between the container and the collar The strainer assemblage may then be pivoted within the collar to the first position such that the orifice 204 may be occluded and covered by a solid portion of the strainer assemblage. The gasket 205 may be compressed by the strainer assemblage such that a liquid-tight seal may be created between the orifice 204 and the solid portion of the strainer assemblage. Thus, liquid and solid ingredients within the container may be trapped completely within the container due to the liquid-tight seals created by the gaskets and the attachment means The flip-top shaker may then be shaken to thoroughly mix the ingredients. FIG. 11 shows a cross-sectional side view through the center of the fully assembled flip-top shaker with the strainer assemblage pivoted to the first position.

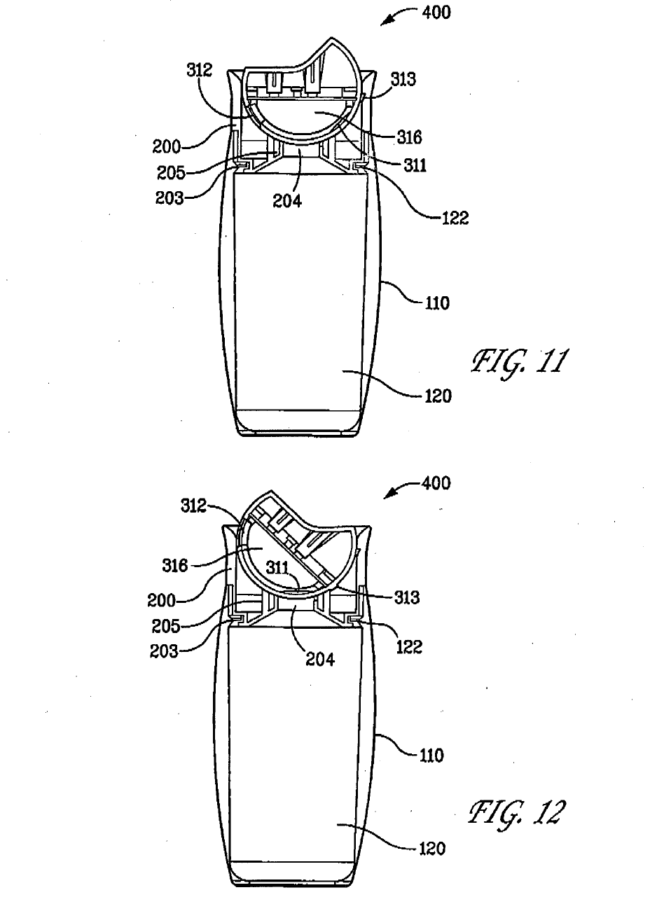

Once the ingredients are mixed, the strainer assemblage may be pivoted within the collar to the second position such that the orifice 311 at least partially allows communication between the container and the outside. The flip-top shaker may then be at least partially tipped for pouting the contents within the container through the orifice and through the strainer assemblage. Thus, the liquid and solid ingredients will pass through the orifice 204 and through the orifice 311. If the orifice 311 contains a straining mechanism, only the liquid ingredients may pass through the orifice while the solid ingredients will remain in the container. From the orifice 311 the ingredients enter the cavity 316. The ingredients may then be guided by the ramp from the orifice 311 to the orifice 314. If the orifice 314 is covered by the straining mechanism, any remaining solid ingredients may be prevented from passing through the straining mechanism. Thus, a passageway exists through the orifice 204, the orifice 311, and the orifice 314. Liquid ingredients may then exit the orifice 314 and may be guided by the circumferential lip 206 into another container. FIG. 12 shows a cross-sectional side view through the center of the fully assembled flip-top shaker with the strainer assemblage pivoted to a second position.

Once fully assembled, the flip-top shaker 400 may be composed of two separable parts, the container 100 and the collar 200 integrated with the strainer assemblage 300. Operation of the flip-top shaker may be accomplished with only one hand. By pivoting the strainer assemblage to the first position, the flip-top shaker may be completely sealed and may thus be shaken with one hand without holding any of the components together to maintain the seal. The strainer assemblage may then be pivoted to the second position opening the passageway through the orifice 204, the orifice 311, and the orifice 314 thus allowing for easy pouring.

What is claimed is:

1. A lid adapted for fitting on a container, comprising:
a collar having a first orifice, wherein said collar is adapted to detachably seal with the container; and
a strainer assemblage having a second orifice and a third orifice, wherein said strainer assemblage is adapted to move between a first position and a second position within said collar, and
wherein said first position provides a liquid-tight seal between said strainer assemblage and said collar and said second position provides a passage through said first, second, and third orifices.

2. The lid of claim 1, wherein said collar further comprises a circumferential lip adapted for pouring from the container.

3. The lid of claim 1, wherein said first orifice is at least partially covered by a straining mechanism.

4. The lid of claim 1, wherein said second orifice is at least partially coveted by a straining mechanism.

5. The lid of claim 1, wherein said third orifice is at least partially coveted by a straining mechanism.

6. The lid of claim 1, wherein said lid further comprises a locking mechanism for releasably locking said strainer assemblage in said first position.

7. The lid of claim 1, wherein said lid further comprises a locking mechanism for releasably locking said strainer assemblage in said second position.

8. The lid of claim 1, wherein said strainer assemblage further comprises partially opposing faces for moving said strainer assemblage between said first position and said second position.

9. A sealable vessel, comprising:
a container adapted for holding solid and liquid ingredients;
a collar having a first orifice, wherein said collar is adapted to detachably seal with said container; and
a strainer assemblage having a second orifice and a third orifice, wherein said strainer assemblage is adapted to move between a first position and a second position within said collar, and
wherein said first position provides a liquid-tight seal between said strainer assemblage and said collar and said second position provides a passage through said first, second, and third orifices.

10. The vessel of claim 9, wherein said container is a double-walled container.

11. The vessel of claim 9, wherein said container is a single-walled container.

12. The vessel of claim 9, wherein said collar further comprises a circumferential lip adapted for pouting from the container.

13. The vessel of claim 9, wherein said first orifice is at least partially covered by a straining mechanism.

14. The vessel of claim 9, wherein said second orifice is at least partially covered by a straining mechanism.

15. The vessel of claim 9, wherein said third orifice is at least partially covered by a straining mechanism.

16. The vessel of claim 9, wherein said lid further comprises a locking mechanism for releasably locking said strainer assemblage in said first position.

17. The vessel of claim 9, wherein said lid further comprises a locking mechanism for releasably locking said strainer assemblage in said second position.

18. The vessel of claim 9, wherein said strainer assemblage further comprises partially opposing faces for moving said strainer assemblage between said first position and said second position.
